(19) United States
(12) Patent Application Publication
(10) Pub. No.: US 2025/0162511 A1
(43) Pub. Date: May 22, 2025

(54) DEVICE HOLDER

(71) Applicants: Gehad Shaat, Frederick, MD (US); Emad Shaat, Tigard, OR (US)

(72) Inventors: Gehad Shaat, Frederick, MD (US); Emad Shaat, Tigard, OR (US)

(21) Appl. No.: 18/507,066

(22) Filed: Nov. 12, 2023

Related U.S. Application Data
(60) Provisional application No. 63/384,410, filed on Nov. 19, 2022.

(51) Int. Cl. B60R 11/00

(52) U.S. Cl. CPC B60R 11/00; B60R 2011/0017; B60R 2011/0059

(57) ABSTRACT

The present invention is a device holder including a backplate for attachment to a vehicle seat headrest via a single high friction elastic band affixed to the backplate, forming a loop parallel to the backplate plane. The inner surface of the band is coated with a friction-enhancing material. An alignment mechanism on the backplate's front surface accommodates and adjusts a connected accessory's position, allowing for the convenient orientation of devices such as mirrors or electronics. This configuration ensures a stable and adjustable mount within a vehicle, optimizing visibility and accessibility for the user. Further, the device holder is configured for one hand installation.

### CROSS-REFERENCE TO RELATED APPLICATIONS

The present application claims priority to U.S. Provisional Application Ser. No. 63/384,410, filed Nov. 19, 2022 entitled “Strapless elastic band for device attachment to headrest” which is hereby incorporated in its entirety at least by reference.

### BACKGROUND OF THE INVENTION

### 1. Field of the Invention

The present invention pertains to the field of support devices, particularly to a versatile holder designed for attachment to a vehicle's seat headrest. More specifically, the invention relates to a device holder that is capable of securing various accessories, such as electronic devices, mirrors, or other suitable items, in an adjustable manner for ease of access and improved visibility within a vehicle

### 2. Description of Related Art

Vehicle headrest accessory mounting devices are known in the art. Many utilize a system of multiple straps and buckles or velcro to attach either a mirror for viewing a rear-facing baby in a car seat or an electronic tablet for viewing by a passenger in the rear seat. However, these are difficult to use and there is room for improvement in this field.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a particular object of the present invention to provide a device holder configured to be installed on a vehicle headrest using only one hand. It is another object of the present invention to provide a device holder configured to receive an accessory device, and including structure enabling the adjustment of the attached accessory device.

In order to do so, a device holder comprising a backplate having a front surface and a back surface, the back surface being configured to attach to a vehicle seat headrest; a single high friction elastic band attached to the backplate and forming a loop with an axis parallel to the plane defined by the backplate, wherein the elastic band includes an inner surface coated with a high friction elastic material; and an alignment mechanism attached to the front surface of the backplate, the alignment mechanism being configured to receive and hold an accessory in an operable position and to permit adjustment of the accessory.

In one embodiment, the high friction elastic material is silicone. In one embodiment, the backplate further comprises a padded backing adhered to the back surface. In one embodiment, the alignment mechanism is a ball and socket joint.

In another aspect of the invention, a device holder is provided, comprising a backplate having a front surface and a back surface; a high friction elastic band attached to the back surface of the backplate and adapted to secure the device holder to a vehicle seat headrest; and an alignment mechanism attached to the front surface of the backplate, wherein the alignment mechanism includes a device connector for attaching and adjusting an accessory in multiple degrees of freedom.

In one embodiment, the device connector is selected from the group consisting of a stud, a quick detach fastener, a mounting plate, and an adjustable clamp. In one embodiment, the alignment mechanism is configured to permit adjustment of the accessory in at least two degrees of freedom.

In yet another aspect of the invention, a method for attaching a device holder to a vehicle seat headrest is provided, the method comprising the steps of: turning a portion of a high friction elastic band of the device holder inside out; placing a backplate of the device holder against the vehicle seat headrest in a desired position; stretching the high friction elastic band over and around the vehicle seat headrest; and returning the inside-out portion of the high friction elastic band to an original position to secure the device holder to the vehicle seat headrest.

In one embodiment, the method is performable using only one hand.

The foregoing has outlined rather broadly the more pertinent and important features of the present invention so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a perspective view of the device holder according to an embodiment of the present invention.

FIG. 2 is a rear view of the device holder according to an embodiment of the present invention.

FIG. 3 is a front view of the device holder according to an embodiment of the present invention.

FIG. 3 is a side view of the device holder according to an embodiment of the present invention.

FIG. 5 shows a method of using the device holder according to an embodiment of the present invention.

FIG. 6 shows the device holder installed in a vehicle according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a support system for a device holder.

It is to be understood that the terminology used herein is for the purpose of describing particular embodiments only and is not intended to be limiting. The terms “a” or “an,” as used herein, are defined to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

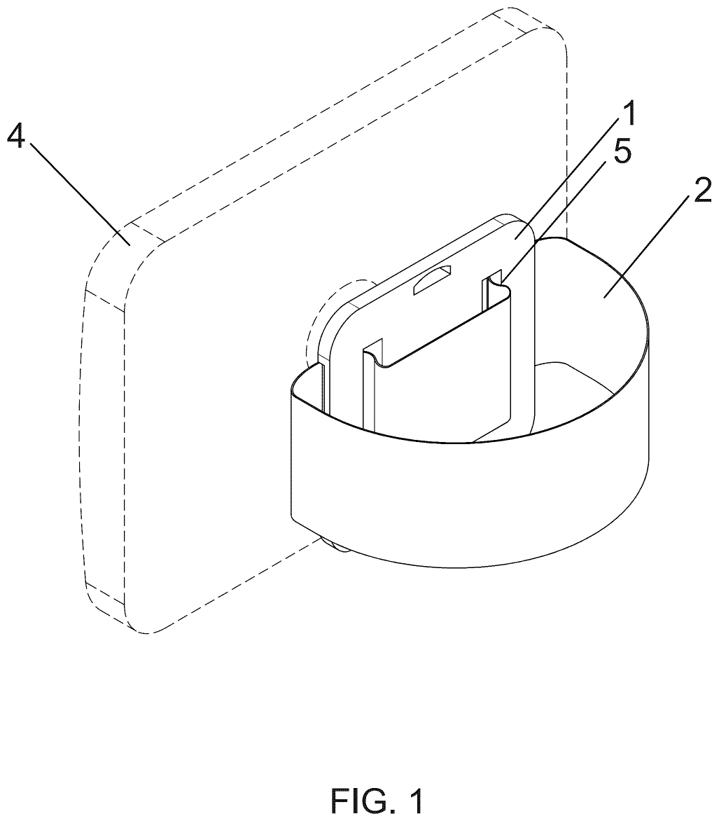

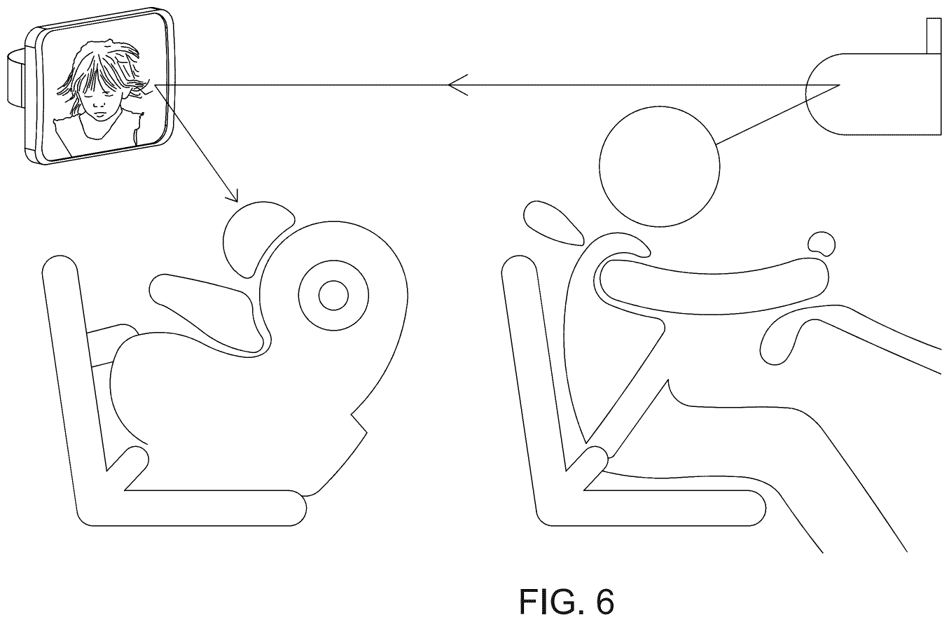

Referring to the accompanying FIGS. 1-6, a device holder is illustrated. In one embodiment, the device holder comprises a high friction elastic band (2) connected to a backplate (1). In some embodiments, the high friction elastic band (2) has an inner surface coated with a high friction elastic material to enhance grip and secure the positioning of a device. The outer surface of the elastic band (2) remains intentionally uncoated, facilitating easier handling and manipulation by the user. Suitable high friction elastic materials for the inner coating include, but are not limited to, silicone, TPR, latex, nitrile, or other low durometer elastomers. In one embodiment, the backplate (1) includes strap buckle slots (5) in which the elastic band (2) is threaded through to retain the elastic band (2) in connection with the backplate (1). It should be understood that other connection methods may be provided to connect the elastic band (2) to the backplate (1) as well known in the art.

In some embodiments, the backplate (1) is fabricated from durable materials such as ABS, Nylon, or HDPE. The interior surface of the backplate (1) may feature a padded backing adhered to it, with potential materials for the padding including EVA foam, TPR, or neoprene, to provide additional protection and comfort. In one embodiment, the backplate (1) has an exterior surface on the opposite side of the interior surface which will have an alignment mechanism (3) (best seen in FIG. 4) attachably mounted for adjusting and holding the user's installed device in an operable position. Various alignment mechanisms can be employed, such as ball and socket joints, universal joints, bendable wire, or pan and tilt mechanisms, which may include movement limiting or locking mechanisms like set screws, adjustment screws, twist lock collets, or other mechanical elements for fixing the position of the device after mounting.

In some embodiments, an accessory (4) is attachably connected to the alignment mechanism, which can be a mirror, electronic display, electronic tablet, cellular phone, portable computer, or another device connector. This accessory can also be a stud for mounting another device or an adjustable clamp for holding a variety of items. The device connector may take the form of an insert, quick detach fastener, mounting plate, or quick disconnect mounting plate, facilitating the attachment and mounting of the user's device. In some embodiments, the mounting plate is equipped with an array of holes or threaded holes for securing the device with fasteners. Quick detach plates, such as those used for small action cameras or Arca style mounting plates, enable quick attachment and detachment of devices.

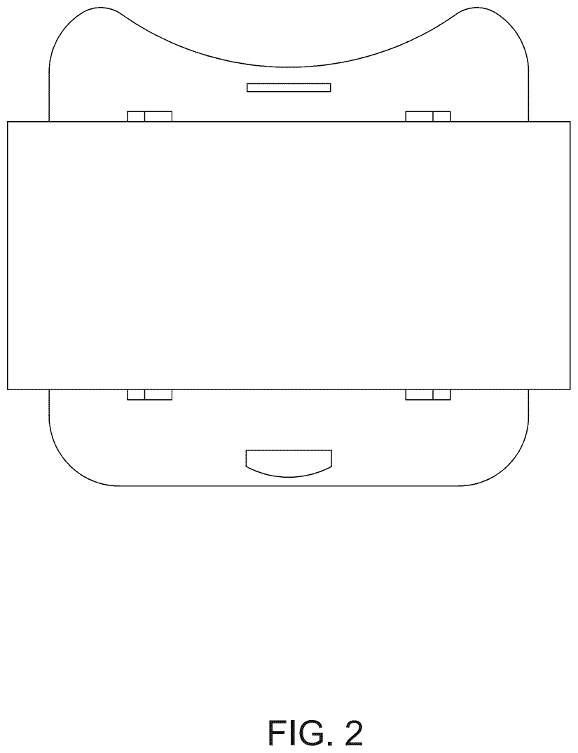

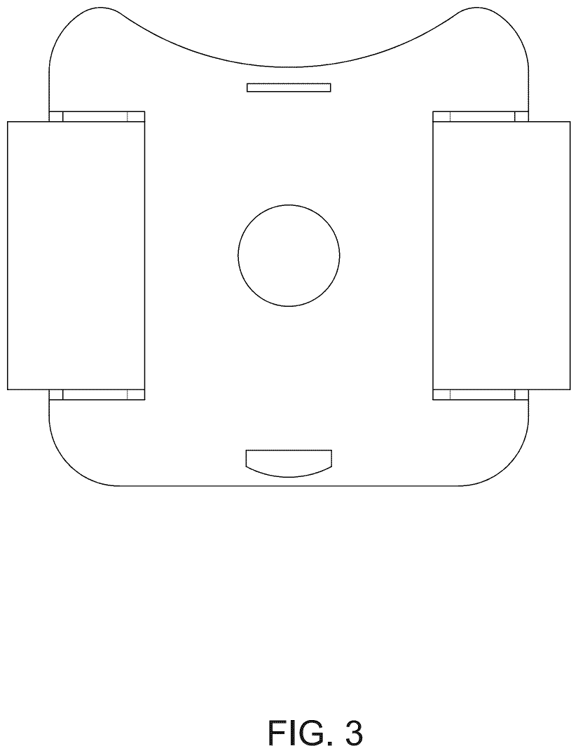

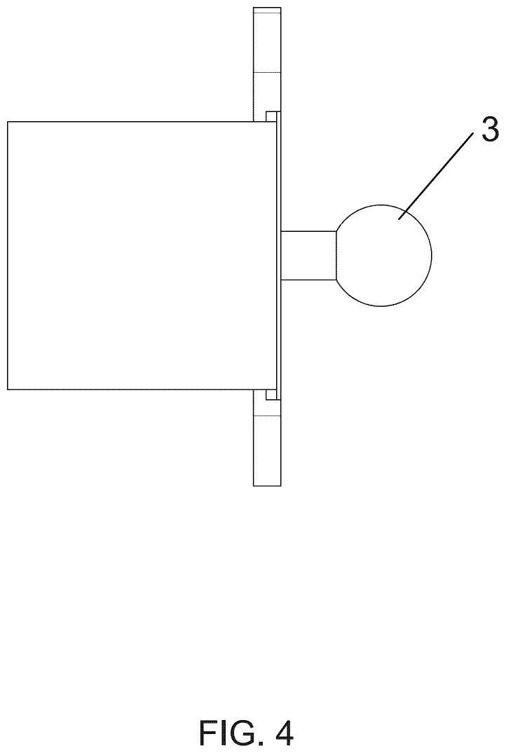

Referring now to FIG. 1, in one embodiment, the accessory (4) is a mirror. This embodiment, when mounted on the headrest of a vehicle, can allow the driver to view a child in a rear-facing car seat. FIG. 2 shows the backplate (1) which may incorporate cutouts or slots to facilitate the attachment of additional adjustable straps and hooks to stabilize the device holder. In some embodiments, as depicted in FIG. 3 and FIG. 4, the device holder includes an alignment mechanism (3) configured as a ball and socket joint.

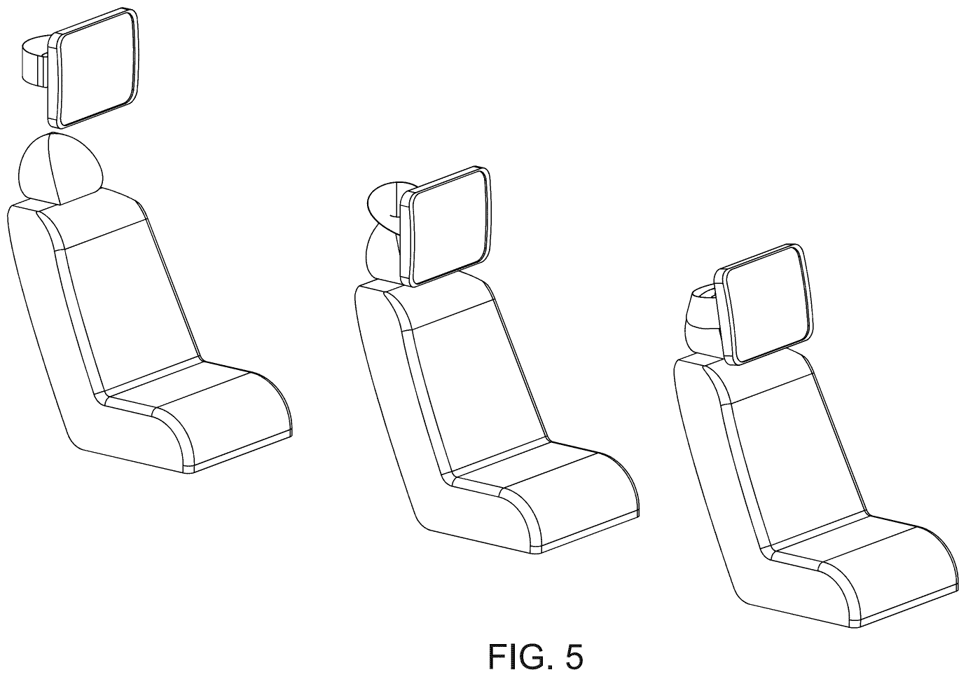

FIG. 5 illustrates a method of using the device holder, which allows for mounting on a car seat headrest with one hand. This can be particularly beneficial when the user's other hand is occupied, for instance, by carrying a child or holding groceries. The steps for installing the device holder with one hand include turning a portion of the high friction elastic band (2) inside out, placing the backplate (1) in position on the vehicle headrest, stretching the elastic band over the vehicle headrest, and flipping the inside-out portion of the elastic band back to its original position.

In some embodiments, the high friction elastic band (2) is positioned perpendicular in relation to the backplate (1), such that the band's center is configured to surround the car seat headrest along a vertical axis. This vertical axis is parallel to the plane defined by the front and back planar surface of the backplate (1). This configuration allows a user to expand the elastic band around the car seat headrest with one hand and secure the device in position at the center of the headrest. The tension in the high friction elastic band maintains the device and backplate (1) securely in position. It is an essential feature of the invention that only the horizontal elastic band is used, as this design precludes the need for vertical straps or bands, thus ensuring compatibility with fixed car headrests that do not have a slot to accommodate threading of straps.

Some one-handed use cases that necessitate the use of a user's hand include, but are not limited to, carrying a child, holding groceries, or managing other objects. The steps of installing the device holder with one hand are as follows: flip a portion of the high friction elastic band (2) inside out, place the backplate (1) of the device holder in the desired position on a vehicle headrest, stretch the high friction elastic band over the vehicle headrest, and then flip the inside-out portion of the elastic band back to its original position. This process positions the high friction surface against the vehicle headrest, ensuring the device holder is securely in place during use.

Although the invention has been described in considerable detail in language specific to structural features, it is to be understood that the invention defined in the appended claims is not necessarily limited to the specific features described. Rather, the specific features are disclosed as exemplary forms of implementing the claimed invention. The terminology and phraseology used in this description and the abstract are for illustrative purposes and should not be considered as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and so fourth members throughout the disclosure (and in particular, claims) are not used to show a serial or numerical limitation but instead are used to distinguish or identify the various members of the group.

What is claimed is:

1. A device holder essentially consisting of:
a backplate having a front surface and a back surface, the back surface being configured to attach to a vehicle seat headrest;
a single high friction elastic band attached to the backplate and forming a loop with an axis parallel to the plane defined by the backplate, wherein the elastic band includes an inner surface coated with a high friction elastic material; and
an alignment mechanism attached to the front surface of the backplate, the alignment mechanism being configured to receive and hold an accessory in an operable position and to permit adjustment of the accessory.

2. The device holder of claim 1, wherein the high friction elastic material is silicone.

3. The device holder of claim 1, wherein the backplate further comprises a padded backing adhered to the back surface.

4. The device holder of claim 1, wherein the alignment mechanism is a ball and socket joint.

5. A device holder comprising:
a backplate having a front surface and a back surface;
a high friction elastic band attached to the back surface of the backplate and adapted to secure the device holder to a vehicle seat headrest; and
an alignment mechanism attached to the front surface of the backplate, wherein the alignment mechanism includes a device connector for attaching and adjusting an accessory in multiple degrees of freedom.

6. The device holder of claim 5, wherein the device connector is selected from the group consisting of a stud, a quick detach fastener, a mounting plate, and an adjustable clamp.

7. The device holder of claim 5, wherein the alignment mechanism is configured to permit adjustment of the accessory in at least two degrees of freedom.

8. A method for attaching a device holder to a vehicle seat headrest, the method comprising the steps of:
turning a portion of a high friction elastic band of the device holder inside out;
placing a backplate of the device holder against the vehicle seat headrest in a desired position;
stretching the high friction elastic band over and around the vehicle seat headrest; and
returning the inside-out portion of the high friction elastic band to an original position to secure the device holder to the vehicle seat headrest.

9. The method of claim 8, wherein the method is performable using only one hand.
